(19) United States
(12) Patent Application Publication
(10) Pub. No.: US 2003/0024167 A1
(43) Pub. Date: Feb. 6, 2003

(54) Central control for windows

(76) Inventor: Chao Hsing Cheng, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/918,804

(22) Filed: Aug. 1, 2001

(51) Int. Cl. E05F 15/08

(52) U.S. Cl. 49/374; 49/372; 49/349; 49/352

(57) ABSTRACT

A window comprises a base and a frame extends from a side of the base. The frame defines a space communicated with at least one slot in the slot of the base. At least one sheet is mounted in the base and movable between the base and the frame via a respective slot. The window is mounted to an inner side of a window opening of a building with the space of the frame aligning with the window opening of the building. Plural windows can be respectively mounted to plural window openings in a building and controlled by a central control such that all of the sheets of the windows can be synchronously moved into the frames or the bases of for expeditious exhaustion of smoke or obstruction of fire.

### BACKGROUND OF THE INVENTION

1. Field of the Invention

The present invention relates to a central control for windows that may open or close all of the windows for expeditious exhaustion of smoke or obstruction of flame. The present invention also relates to plural windows with improved airtight and soundproof effect as well as expeditious, convenient central control.

2. Description of the Related Art

A typical horizontal window comprises two panes respectively mounted in two sashes that can be moved horizontally. Such a horizontal window can only be opened to a half of the opening for mounting the window, which results in poor permeability of air and poor exhaustion of smoke during fire. FIG. 11 of the drawings illustrates a conventional window for expeditious exhaustion of smoke. The window comprises a frame 4′ having plural frame sections each of which a sash 1′ is pivotally mounted. Each of the sashes 1′ is operably connected to a linking device 2′, which, in turn, is controlled by a control 3′. Thus, the sashes 1′ can be pivoted outward synchronously under operation of the control 3′. Nevertheless, screen windows cannot be mounted to such a window and thus cannot prevent from invasion of insects. In addition, such a window fails to provide an anti-theft function when required. Further, the sashes 1′, when opened, are exposed outside the building, which adversely affects an overall aesthetic appearance. Further, it is difficult to install airtight strips on the frame 4′ and thus fails to provide a satisfactory soundproof effect even if all of the sashes 1′ are closed.

### SUMMARY OF THE INVENTION

An object of the present invention is to provide a window having a base and a frame provided on top of the base. A sheet received in the frame can be completely moved into the base to thereby provide a larger space for expeditious exhaustion of smoke. The sheet can be moved back into the frame for obstruction of flame when required.

Another object of the present invention is to provide plural windows in which all of the sheets of the windows can be synchronously moved into the frames or the bases of the windows, respectively.

A further object of the present invention is to provide plural windows that can be manually or automatically controlled to expeditiously expel smoke or obstruct flame.

Still another object of the present invention is to provide an additional frame juxtaposed to a window opening of a building, an additional sheet can be mounted in the window opening.

Yet another object of the present invention is to provide two bases and a frame connected between the bases. Each base has a sheet mounted therein. The sheets of the bases can be moved into the frame and thus isolate a space defined in the frame.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view, partly exploded, of a window in accordance with the present invention.

FIG. 2 is a perspective view of the window in accordance with the present invention.

FIG. 3 is a sectional view illustrating use of the window in accordance with the present invention, wherein a sheet in the window is received in a base of the window.

FIG. 4 is a sectional view similar to FIG. 3, wherein the sheet in the window is moved into a frame of the window.

FIG. 5 is a schematic view illustrating a central control for plural windows in accordance with the present invention.

FIG. 6 is a sectional view illustrating a modified embodiment of the window in accordance with the present invention.

FIG. 7 is a sectional view similar to FIG. 6, wherein one of the sheets in the window is moved into a frame of the window.

FIG. 8 is a sectional view illustrating another modified embodiment of the window in accordance with the present invention.

FIG. 9 is a perspective view of a further modified embodiment of the window in accordance with the present invention.

FIG. 10 is a sectional view illustrating use of the window in FIG. 9.

FIG. 11 is a schematic view of a conventional window.

### DETAILED DESCRIPTION OF THE PREFERRED EMBODIMENTS

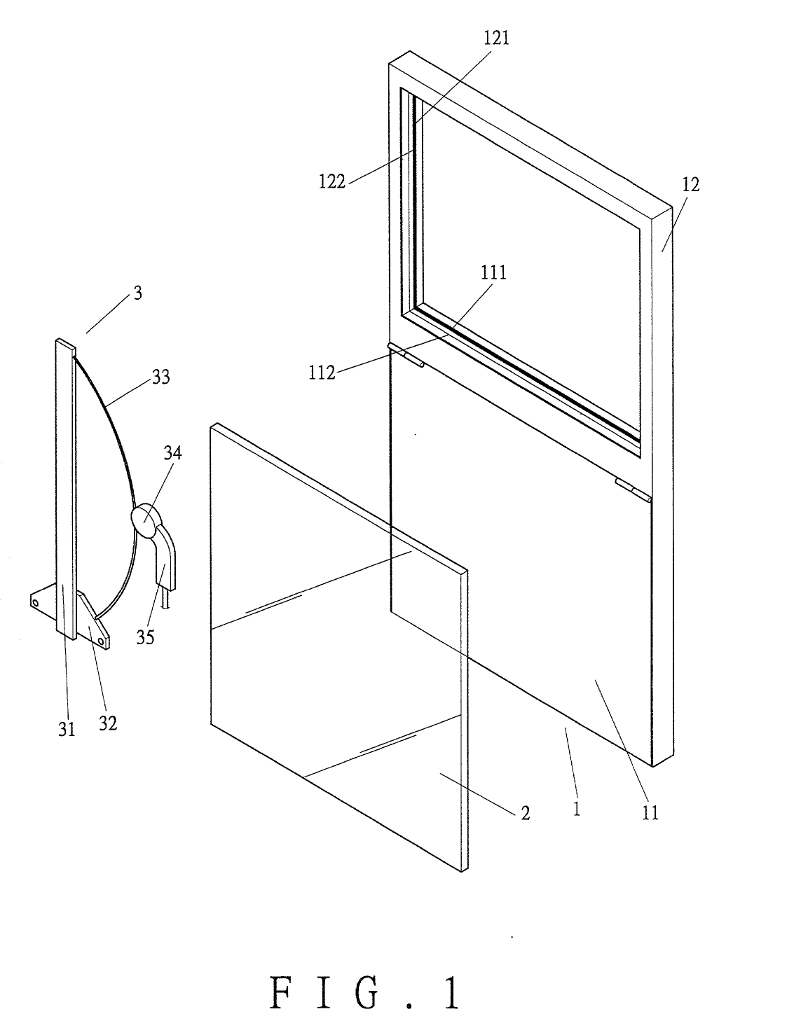

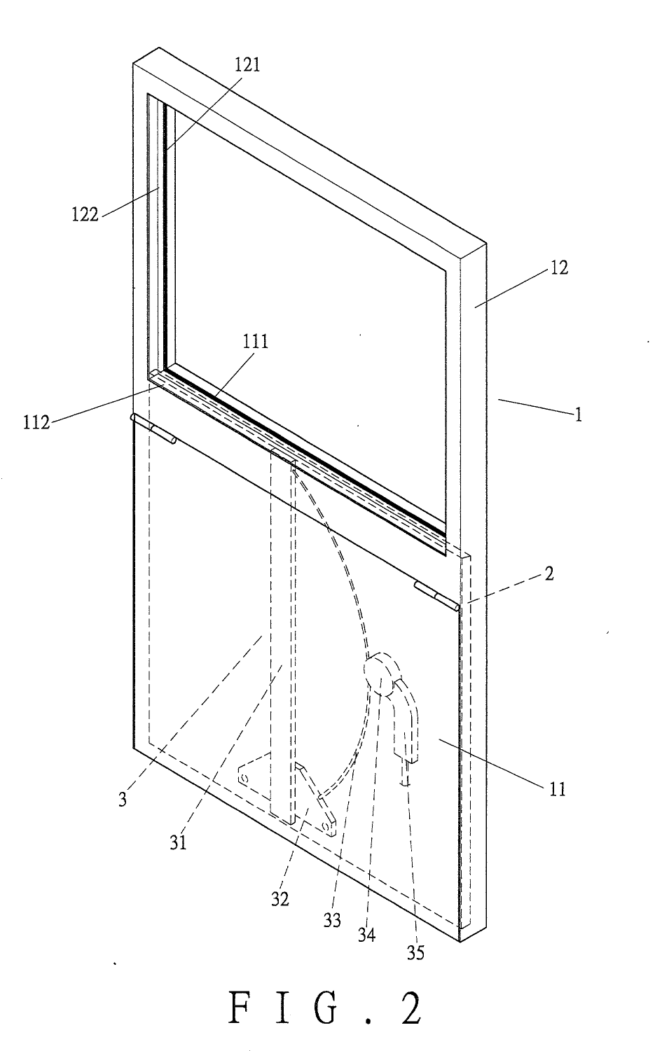

Referring to FIGS. 1 through 10 and initially to FIGS. 1 and 2, a window in accordance with the present invention generally includes a base 1, at least one sheet 2, and a moving device 3 for moving the sheet 2. In this embodiment, only one sheet 2 is movably mounted in the base 1. The base 1 comprises a box 11 and a frame 12 extends from a side of the box 11. At least one slot 111 is defined in the side of the box 11 and through which a respective sheet 2 passes. The frame 12 defines a space (not labeled) communicated with the slot 111. The frame 12 further includes two mutually facing grooves 121 respectively defined in two lateral sides of the frame 12 for receiving lateral edges of the sheet 2. Airtight strips 112 and 122 are mounted to the slot 111 and the grooves 121 for providing desired airtight effect when the sheet 2 is moved into the frame 12.

The sheet 2 has a width slightly smaller than that of the frame 12 and is mounted to the moving device 3. The sheet 2 may be a pane, fireproof plate, anti-theft grid, screen plate, etc.

The moving device 3 is mounted in the box 11 for moving the sheet 2. The moving device 3 comprises a guide member 31 securely attached to the box 11, a carrier 32 securely attached to the sheet 2 to move therewith, a cable 33, a motor 34, and a reduction gear 35. The cable 33 is slidably mounted to the guide member 31 and connected to the motor 34 as well as the reduction gear 35. When the motor 34 is activated by a control (not shown), the cable 33 and the carrier 32 are moved to thereby move the sheet 2 along the desired direction (vertical in this embodiment).

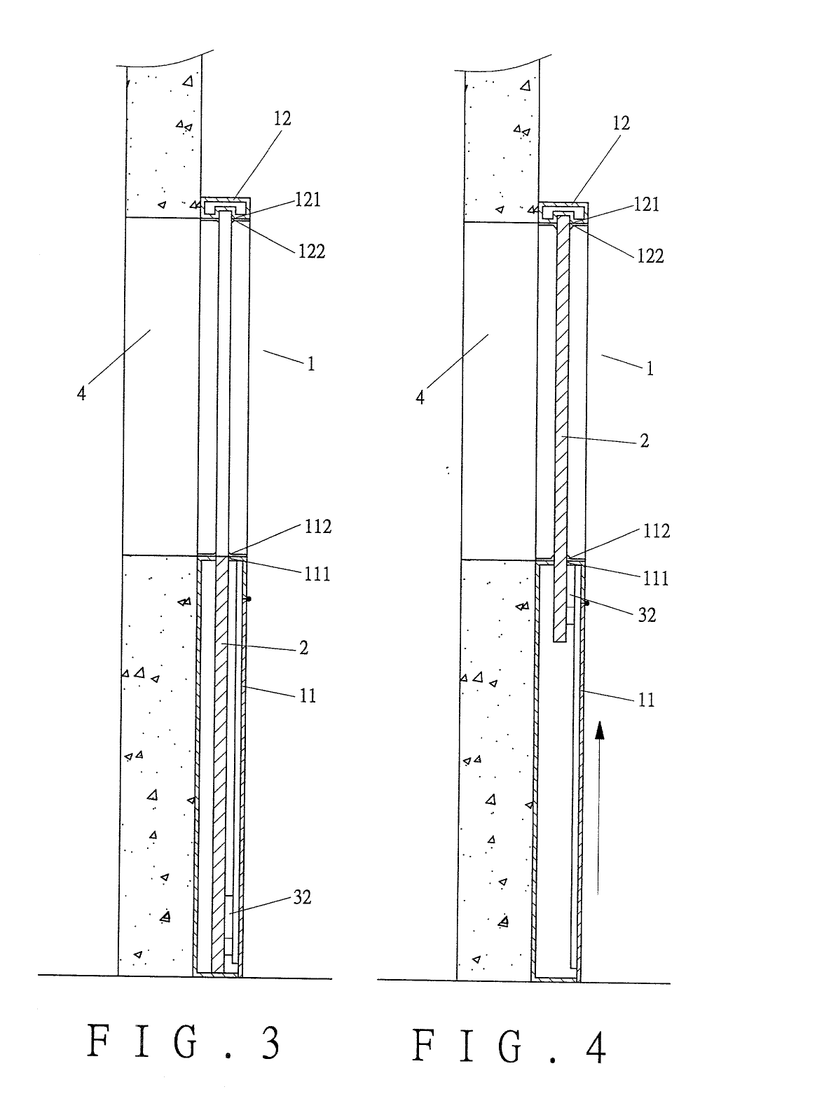

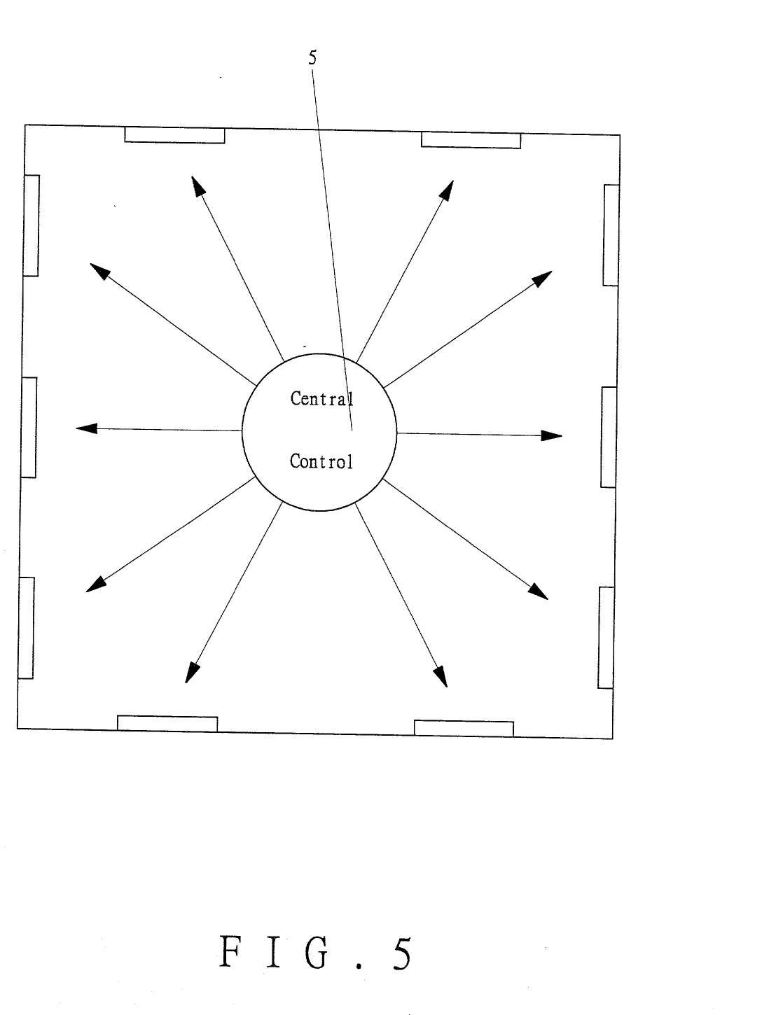

As illustrated in FIGS. 3 through 5, in accordance with the present invention, plural windows are provided for plural window openings 4 of a building. In this embodiment, each base 1 can be mounted to an inner side of a respective window opening 4 of the building with the space of each frame 12 aligning with the respective window opening 4. Thus, each of the sheets 2 can be manually controlled or controlled by a central control 5 (FIG. 5) to activate all of the moving devices 3, thereby synchronously moving all of the sheets 2 from the bases 1 into the frames 12 or vice versa. Thus, all of the sheets 2 can be synchronously moved from the bases 1 into the frames 12 for expeditious exhaustion of smoke or from the frames 12 into the bases 1 for expeditious obstruction of fire. In addition, a smoke sensor, anti-theft knocking detector, fire alarm, camera, etc. can be mounted to at least one of the sheets 2 and controlled by the central control 5 to thereby provide detection of fire and/or theft.

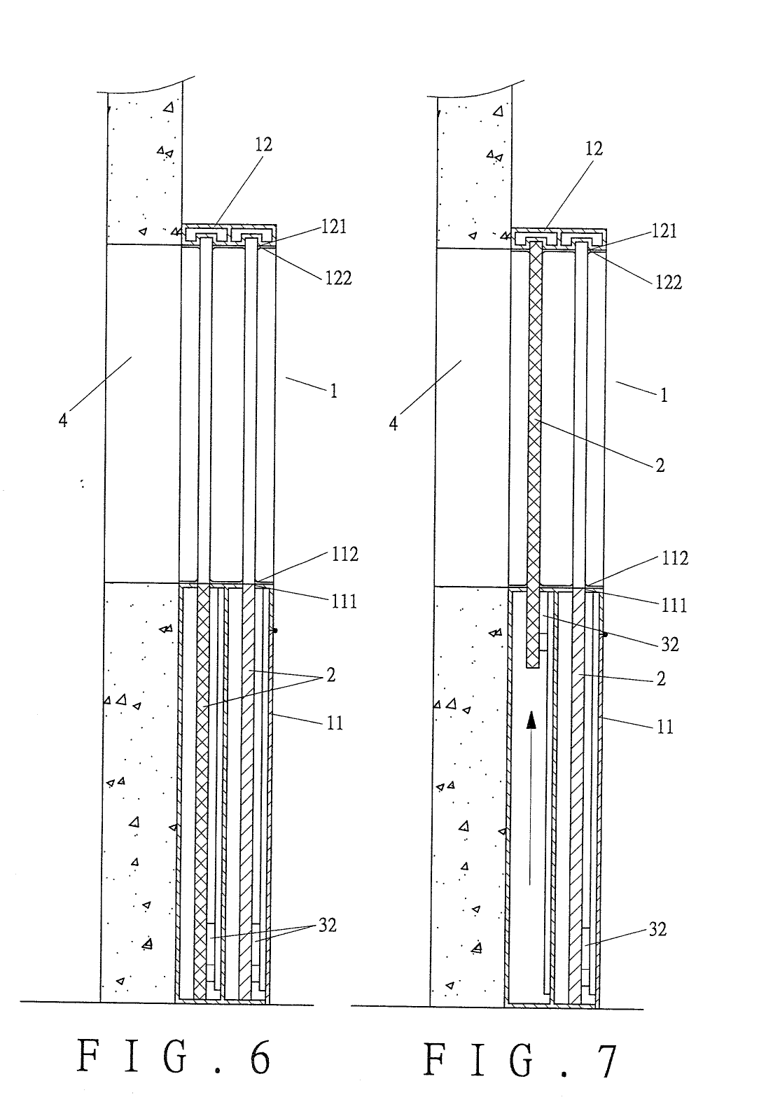

Referring to FIGS. 6 and 7, the base 1 may comprise two movable sheets 2, wherein one of the sheets 2 is a screen and the other is a pane. Thus, as illustrated in FIG. 7, the pane 2 is usually received in the base 1 and the screen 2 is received in the frame 12, thereby allowing air permeation. In an alternative embodiment, both of the sheets 2 are panes to thereby provide improved soundproof effect. Further, the base 1 may comprise an anti-theft grid and/or a fireproof plate to thereby provide required anti-theft and anti-fire function.

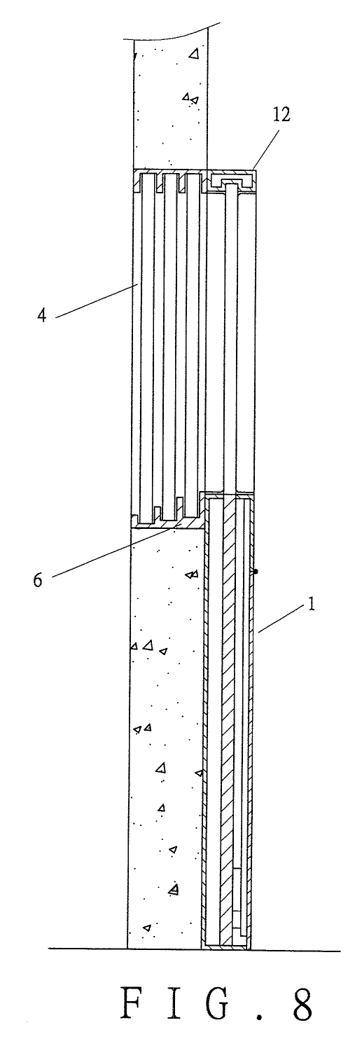

Referring to FIG. 8, in a further modified embodiment of the invention, the window opening 4 may comprise at least one sash 6 for mounting a screen, pane, anti-theft grid, etc.

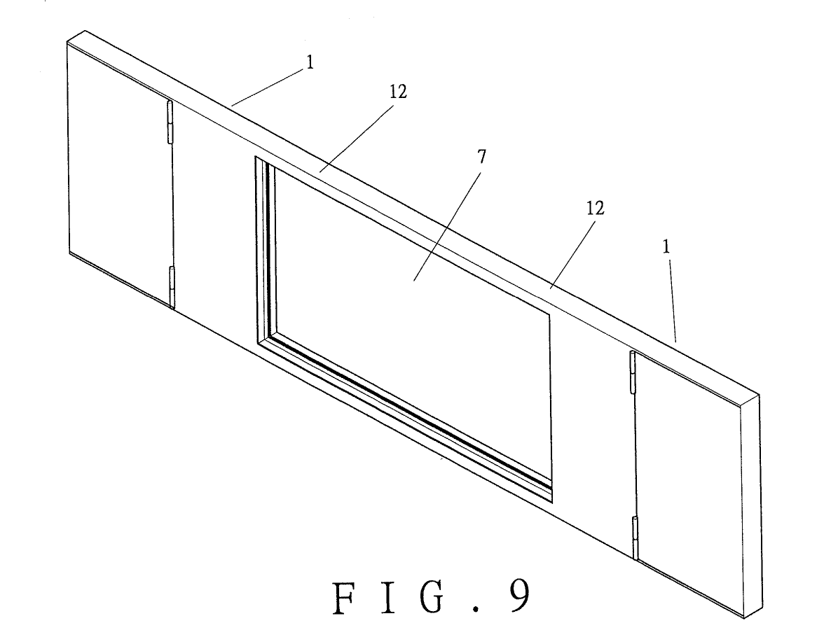

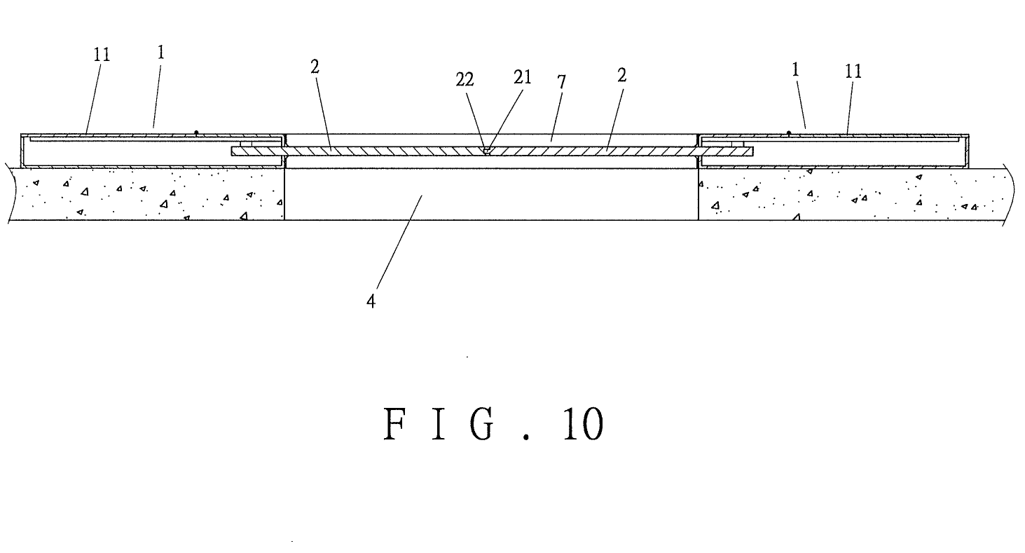

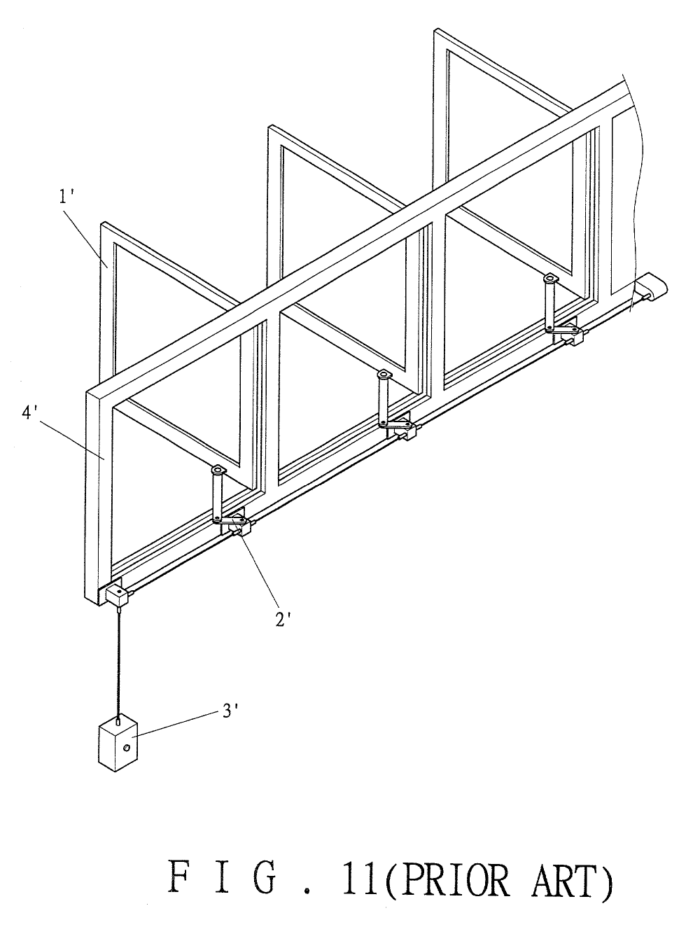

Referring to FIGS. 9 and 10, another embodiment of the invention in accordance with the present invention comprises two bases 1 and a frame 12 connected between the bases 1. The frame 12 defines a space 7 aligned with the window opening 4. Each base 1 comprises a movable sheet 2 mounted therein. The sheets 2 can be moved out of the bases 1 into the space 7 to thereby isolate the space 7 and the window opening 4. One of the sheets 2 may include a protrusion or flange 21 and the other may comprise a recess 22 for receiving the flange 21.

According to the above description, it is appreciated that the plural windows in accordance with the present invention can be synchronously opened or closed to allow expeditious exhaustion of smoke, escape of people, or obstruction of fire. In addition, installation of the window(s) will not deconstruct the building and not adversely affect the appearance of the building. Furthermore, the base may include more than one movable sheet according to need, and plural bases can be combined for a larger window opening. Further, plural windows can be controlled by a central control for expeditious control with increased safety as well as theft detection and fire detection.

Although the invention has been explained in relation to its preferred embodiment, it is to be understood that many other possible modifications and variations can be made without departing from the scope of the invention as hereinafter claimed.

What is claimed is:

1. A window adapted to be mounted to an inner side of a window opening of a building, the window comprising:
a base comprising a side having at least one slot;
a frame extending from the side of the base and defining a space communicated with said at least one slot; and
at least one sheet mounted in the base and movable between the base and the frame via said at least one slot;
the window being adapted to be mounted to an inner side of a window opening of a building with the space of the frame aligning with the window opening of the building.

2. The window as claimed in claim 1, wherein said at least one sheet is one of a pane, screen, fireproof plate, and anti-theft grid.

3. The window as claimed in claim 1, further comprising an airtight strip mounted to said at least one slot.

4. The window as claimed in claim 1, wherein the frame comprises at least one pair of mutually facing grooves in two lateral sides thereof, said at least one sheet being guided by said at least one pair of mutually facing grooves.

5. The window as claimed in claim 4, further comprising an airtight strip to each of said at least one pair of mutually facing grooves.

6. The window as claimed in claim 1, further comprising at least one of a smoke sensor, anti-theft knocking detector, fire alarm, and camera mounted to said at least one sheet.

7. The window as claimed in claim 6, wherein said at least one of a smoke sensor, anti-theft knocking detector, fire alarm, and camera is manually controlled.

8. The window as claimed in claim 6, further comprising a central control for controlling said at least one of a smoke sensor, anti-theft knocking detector, fire alarm, and camera.

9. The window as claimed in claim 1, wherein the window opening further comprises at least one sash for mounting an additional said sheet.

10. The window as claimed in claim 1, further comprising at least one sash adapted to be mounted in the window opening for mounting one of a screen, a pane, and an anti-theft grid.

11. The window as claimed in claim 1, further comprising means for moving said at least one sheet between the base and the frame.

12. The window as claimed in claim 1, wherein the base further comprises at least one of an anti-theft grid and a fireproof plate mounted thereto.

13. A window comprising:
two bases each comprising a side having a slot;
a frame connected between the sides of the bases, the frame defining a space communicated with the slots; and
two sheets respectively mounted in the bases, each of the sheets being movable between an associated one of the bases and the frame via an associated one of the slots.

14. The window as claimed in claim 13, wherein one of the sheets comprises a flange and the other sheet comprises a recess for receiving the flange.

15. The window as claimed in claim 14, wherein each said sheet is one of a pane, screen, fireproof plate, and anti-theft grid.

16. The window as claimed in claim 13, wherein each of the bases further comprises at least one of an anti-theft grid and a fireproof plate mounted thereto.

17. The window as claimed in claim 13, wherein the window is adapted to be mounted in an inner side of a window opening of a building with the space of the frame aligning with the window opening of the building.

18. A combination of a central control and plural windows adapted to be mounted to an inner side of an associated one of plural window openings of a building, comprising:
plural windows each comprising:
a base comprising a side having at least one slot;
a frame extending from the side of the base and defining a space communicated with said at least one slot; and
at least one sheet mounted in the base and movable between the base and the frame via said at least one slot;
a central control for controlling synchronous movement of said at least one sheet between the base and the frame of each of the windows;
each of the windows is adapted to be mounted to an inner side of an associated one of plural window openings of a building with the space of each said frame aligning with the associated one of the window openings of the building.

19. The combination of a central control and plural windows as claimed in claim 18, further comprising means for moving said at least one sheet between the base and the frame of each said window.

20. The combination of a central control and plural windows as claimed in claim 18, wherein each of the bases further comprises at least one of an anti-theft grid and a fireproof plate mounted thereto.
